(19) United States
(12) Patent Application Publication
(10) Pub. No.: US 2025/0081110 A1
(43) Pub. Date: Mar. 6, 2025

(54) SYSTEMS, METHODS, AND DEVICES FOR ENHANCED POWER SAVING VIA DYNAMIC REFERENCE SIGNALLING

(71) Applicant: Apple Inc., Cupertino, CA (US)

(72) Inventors: Qiming Li, Beijing (CN); Dawei Zhang, Saratoga, CA (US); Fangli Xu, Beijing (CN); Haijing Hu, Los Gatos, CA (US); Huaning Niu, San Jose, CA (US); Jie Cui, San Jose, CA (US); Manasa Raghaven, Sunnyvale, CA (US); Xiang Chen, Campbell, CA (US); Yang Tang, San Jose, CA (US); Yuqin Chen, Beijing (CN)

(21) Appl. No.: 18/724,985

(22) PCT Filed: Jan. 10, 2022
(86) PCT No.: PCT/CN2022/071070

§ 371 Date: Jun. 27, 2024

(51) Int. Cl. H04W 52/02; H04L 5/00; H04W 24/08

(52) U.S. Cl. CPC H04W 52/0245; H04L 5/0048; H04W 24/08

(57) ABSTRACT

Techniques, described herein, include solutions for enabling a user equipment (UEs) to operate in a power saving mode (PSM) by performing radio link monitoring (RLM), beam failure detection (BFD), and radio resource management (RRM) based on one or more reference signals with a decreased periodicity. The reference signals may include system synchronizations blocks (SSBs), a channel state information (CSI) m signal (CSI-RSs), or a combination thereof. A base station may be configured to operate as a master cell group (MCG) node or a secondary cell group (SCG) node and may transmit reference signals with an increased periodicity to UEs in an active mode of operation while also transmitting reference signals with a decreased periodicity to UEs in a PSM.

### FIELD

This disclosure relates to wireless communication networks including techniques for conserving power within wireless communication networks.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes addressing how wireless devices manage power, which may include mobile power sources such as batteries, while remaining connected to the network.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of a master cell group (MCG) and a secondary cell group (SCG) of a wireless communication network.

FIG. 3 is a diagram of an example overview of using an enhanced power saving according to one or more implementations described herein.

FIG. 4 is a diagram of an example of a process for implementing enhanced power saving according to one or more implementations described herein.

FIG. 5 is a diagram of an example of a process for implementing enhanced power saving at a user equipment (UE).

FIG. 6 is a diagram of an example of a process for determining conditions for implementing enhanced power saving.

FIG. 7 is a diagram of example of UE-specific implementation of enhanced power saving according to one or more implementations described herein.

FIG. 8 is a diagram of example of a cell-specific implementation of enhanced power saving according to one or more implementations described herein.

FIG. 9 is a diagram of example of a frequency-specific implementation of enhanced power saving according to one or more implementations described herein.

FIGS. 10-18 are diagrams of examples of enhanced radio resource control (RRC) information elements (IEs) for implementing enhanced power saving according to one or more implementations described herein.

FIG. 19 is a diagram of an example table for implementing enhanced power saving during discontinuous reception (DRX) according to one or more implementations described herein.

FIG. 20 is a diagram of an example of components of a device according to one or more implementations described herein.

FIG. 21 is a diagram of example interfaces of baseband circuitry according to one or more implementations described herein.

FIG. 22 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and other network nodes. UEs and base stations may implement various techniques for establishing and maintaining connectivity. In certain situations, a UE may implement multi-RAT (radio access technology) dual connectivity (MR-DC), where the UE may be connected to a master radio access network (RAN) node (e.g., a master base station) and one or more secondary RAN nodes (e.g., a secondary base station). The master RAN node may operate as a controlling entity for the overall connection between the UE and the network, using the secondary RAN node for additional data capacity. The master RAN node may be part of a master cell group (MCG) and the secondary RAN node may be part of a secondary cell group (SCG). Additionally, MR-DC may generally refer, or apply to, various new radio (NR) or next generation (NG or NGEN) dual connectivity (DC) network arrangements, including evolved universal terrestrial radio access (E-UTRA) NR DC (EN-DC), NG EN-DC, NR E-UTRA DC (NE-DC), and so on.

A UE may perform radio link monitoring (RLM) on an active downlink (DL) bandwidth part (BWP) of a primary serving cell (PCell) of an MCG. If the UE is configured with a secondary cell group (SCG), then the UE may also monitor DL radio link quality on the active DL BWP of the primary SCG Cell (PSCell). The PCell and PSCell may be collectively referred to as a SpCell (Special Cell). RLM may include functions at the physical (PHY) layer, media access (MAC) layer, and radio resource control (RRC) layer. RLM at the physical layer may include monitoring DL radio link quality and sending measurement results to upper layers. RLM at the MAC layer may include beam failure detection (BFD) and recovery, RLM at the RRC layer may include configuring PHY and MAC layer; radio link failure detection and RRC-establishment (and RRC re-establishment). RRM may be configured to ensure channels, frequencies ranges, beams, and network infrastructure are used appropriately given the constraints of the overall system and capabilities of individual devices and changing needs or requirements of devices. An example of RRM may include monitoring network conditions and activating/deactivating/changing SCGs or SCells for one or more UEs.

RLM may be performed on based on different RLM reference signal (RLM-RS) resources, which may be configured by a base station through RRC messaging (e.g., via the RadioLinkMonitoringConfig information element (IE)). Examples of these resources may include system synchronizations blocks (SSBs), channel state information (CSI) resource signals (CSI-RSs), or a combination of SSBs and a CSI-RS. Radio resource management (RRM) may include processes and algorithms for controlling transmission parameters and conditions between the UE and base station, such as transmit power, beamforming, data rates, handover criteria, modulation scheme, error coding scheme, etc. The rate with which reference signals (e.g., SSBs and a CSI-RS) are transmitted by a base station and measured by a UE for RLM, BFD, etc., may be referred to as a periodicity. And while current technology includes a technique for communicating reference signals to UEs for measurement, currently available techniques fail to provide a dynamic signaling technique that may include reference signals transmitted at periodicities consistent with the power usage of different types of devices that could perform RLM, BFD, etc., less frequently than other devices. Examples of such devices may include stationary (or low mobility) wireless devices, mobile devices located well-within a cellular range of a base station, changes in an activation (e.g., a deactivation) of a SCG, and so on.

Techniques described herein provide solutions for enabling UEs to use different reference signals (RSs) to perform RLM, BFD, and RRM. Examples of the reference signals (or set of reference signals) may include SSB and CSI-RS. One set of reference signals may be provided at a higher periodicity (for UEs operating in an active mode) while another set of reference signals may be provided at a lower periodicity (for UEs operating in a PSM). Each set of reference signals may include SSBs, a CSI-RS, and one or more other types of information for performing RLM, BFD, and/or RRM. Whether a UE is to operate in an active mode or a PSM may depend on an explicit indication from the base station (e.g., a radio resource control (RRC) message) or an implicit indication determined by the UE. Examples of an implicit indication may include whether the UE is located near an edge of a cell, whether the UE is a low-mobility UE, whether a base station operating as an SCG has been deactivated, whether a BWP used by the base station is dormant, etc. Reducing the periodicity of reference signals used may place a UE in a power saving mode (PSM) since a decrease in the periodicity may cause the UE to perform RLM, BFD, and RRM less frequently. In addition, the techniques described herein include solutions for implementing the PSM (e.g., causing a UE to use lower periodicity reference signals to perform RLM, BFD, and RRM) on a per-UE basis, a per-cell basis, a per-frequency range basis, or on a per-MCG or per-SCG basis. Performing RLM, BFD, and RRM using lower periodicity reference signals (e.g., PSM reference signals) may be referred to as a relaxed version of RLM, BFD, and RRM.

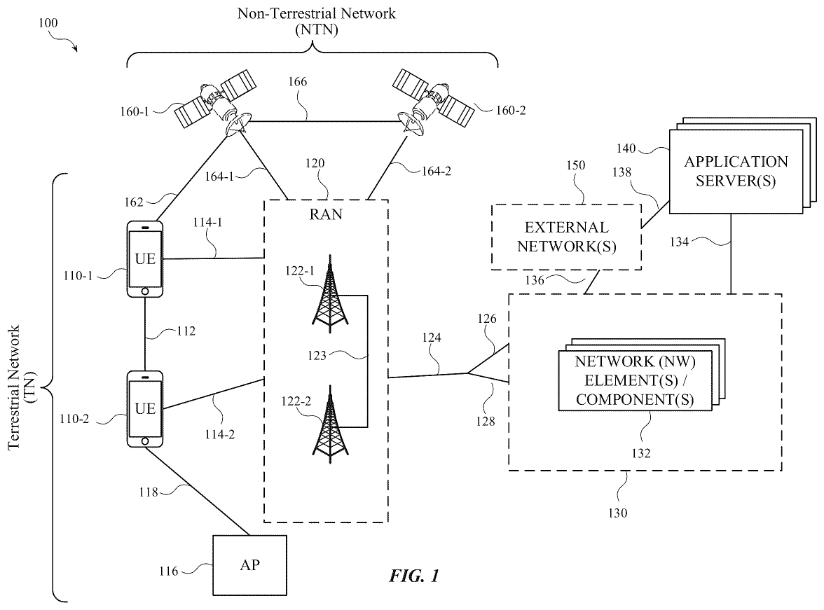

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, network 100 may include a non-terrestrial network (NTN) comprising one or more satellites 160 (e.g., of a global navigation satellite system (GNSS)) in communication with UEs 110 and RAN 120.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 101, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network nod 122.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 1207 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and also to implementation where the base station, RAN node 122, etc., is a non-terrestrial network node (e.g., satellite 160).

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 110 and the RAN nodes 122 may also operate using stand-alone unlicensed operation where the UE may be configured with a PCell, in addition to any SCells, in unlicensed spectrum.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VoIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

As shown, example network 100 may include an NTN that may comprise one or more satellites 160-1 and 160-2 (collectively, “satellites 160”). Satellites 160 may be in communication with UEs 110 via service link or wireless interface 162 and/or RAN 120 via feeder links or wireless interfaces 164 (depicted individually as 164-1 and 164). In some implementations, satellite 160 may operate as a passive or transparent network relay node regarding communications between UE 110 and the terrestrial network (e.g., RAN 120). In some implementations, satellite 160 may operate as an active or regenerative network node such that satellite 160 may operate as a base station to UEs 110 (e.g., as a gNB of RAN 120) regarding communications between UE 110 and RAN 120. In some implementations, satellites 160 may communicate with one another via a direct wireless interface (e.g., 166) or an indirect wireless interface (e.g., via RAN 120 using interfaces 164-1 and 164-2).

Additionally, or alternatively, satellite 160 may include a GEO satellite, LEO satellite, or another type of satellite. Satellite 160 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and implementation, where the base station, RAN node 122, etc., is a non-terrestrial network node (e.g., satellite 160). As described herein, UE 110 and base station 122 may communicate with one another, via interface 114, to enable enhanced power saving techniques.

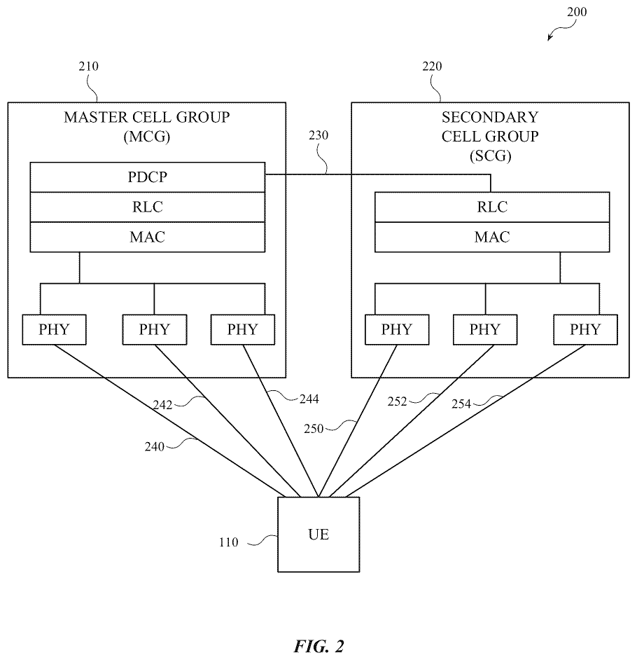

FIG. 2 is a diagram of an example 200 of a master cell group (MCG) 210 and a secondary cell group (SCG) 220 of a wireless communication network. An MCG may include a group of cells associated with a master node, comprising a primary cell (PCell) and one or more secondary cells (SCells). An SCG may include a group of serving cells associated with a secondary node, comprising a primary cell of the secondary cell group (PSCell) and optionally one or more secondary cells (SCells).

MCG 210 may be implemented by one or more base stations 122 and may include one or more layers. Examples of such layers may include a packet data convergence protocol (PDCP) layer, a radio link control (RLC) layer, a media access control (MAC) layer, and multiple physical (PHY) layers. Each PHY layer may correspond to a different implementation of a cell with respect to UE 110. Additionally, or alternatively, the PHY layers may operate in combination (e.g., be managed, controlled by, etc.) the PDCP, layer RL:C, layer, and MAC layers. In some implementations, one PHY layer 240 may operate as a primary cell (PCell) or a special cell (SpCell) and other PHY layers 242 and 244 may operate to secondary cells (SCells) to the PCell.

SCG 220 may be implemented by one or more base stations 122 and may include multiple layers as well, including an RLC layer, a MAC layer, and multiple PHY layers. SCG 220 may not include a PDCP layer, but instead may rely on the PDCP layer of MCG 210 via connection 230. Similar to the PHY layers of MCG 210, the PHY layers of SCG 220 may each function or operate as a cell with respect to UE 110. In some implementations, one PHY layer 250 may operate as a primary cell (PCell) to PHY layers 252 and 254 operating as secondary cells to the PCell of PHY layer 250. As such, a special cell (SpCell) as described herein, may include a PCell of MCG 210 or a PCell of SCG 220. A scheduling secondary cell (sSCell), as described herein, may include a secondary cell (SCell) to any SpCell, which may each reside in the same cell group or different cell groups. Further, while FIG. 2 includes only 2 cell groups, implementation discussed herein may be applied to multiple cell groups operating in synchronization or collaboration with one another to perform the techniques described herein. Furthermore, each cell group (e.g., MCG and/or SCG) may be implemented on one or more base station, and a cell group operating as either an MCG or SCG may change, and cells within a cell group (e.g., a SpCell, SCell, sSCell, etc.) may be changed by activation, deactivation, dormancy, etc.

MCG 210 and SCG 220 may be involved in a dual connectivity scenario with UE 110, in which case a random access channel (RACH) procedure, and the like, may be directed to MCG 210. Additionally, MCG 210 and SCG 220 may each include a PCell (e.g., 240 and 250), and a PCell may be referred to herein as a special cell or special primary cell, represented as SpCell. Further, a secondary cell (SCell) of either MCG 210 or SCG 220 may operate as a scheduling secondary cell (sSCell) configured to provide configuration, scheduling, activation, deactivation, and other functions or commands toward a SpCell of either MCG 210 or SCG 220. As such, a base station, a baseband processor of a base station, etc., may include a base station of MCG 210 and/or SCG 220 controlling, managing, enabling, etc., a sSCell, of either MCG 210 and/or SCG 220, and/or a SpCell of either MCG 210 and/or SCG 220, which may include additional SCells or SpCells within either MCG 210 and/or SCG 220.

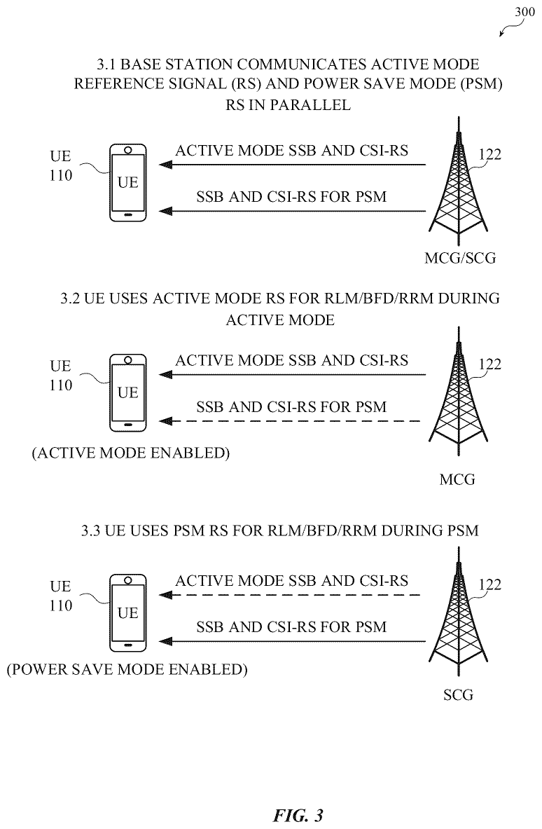

FIG. 3 is a diagram of an example overview 300 of using an enhanced power saving according to one or more implementations described herein. As shown, base station 122 may operate as an MCG 210 and/or SCG 220 with respect to a particular UE 110. Base station 122 may communicate a reference signals for UEs 110 operating in an active mode and a PSM (at 3.1). The reference signals may include SSBs and a CSI-RS communicated at different periodicities. The reference signal for active mode UEs 110 may have a higher periodicity than the reference signal for UEs 110 in a power safe mode. Active mode may include a UE 110 in recent or ongoing communication with base station 122. PSM may include a UE 110 receiving lower-periodicity reference signals due, for example, to being located near the edge of a cell, being stationary, having a recently deactivated SCG 220, or a BWP for the reference signal going dormant. In some implementations, base station 122 may be an MCG 210 and a SCG 220 for one or more UEs 110, such that base station 122 may be transmitting SSBs and CSI-RS at multiple periodicities (e.g., for active mode UEs 110 and PSM UEs 110, respectively). UEs 110 may use the reference signals to perform RLM, BFD, and RRM. In some implementations, UE 110 may be configured to concurrently monitor reference signals in an active mode of operation and a PSM of operation. For example, UE 110 may be configured to operating in an active mode to monitor a reference signal from a base station of an MCG while operating in a PSM to monitor a reference signal from a base station of a SCG.

In some implementations, base station 122 may be an MCG 210 for UE 110 (at 3.2). In such scenarios, base station 122 may transmit a reference signal, with SSBs and a CSI-RS, to UE 110 in accordance with an active mode periodicity. In such scenarios, base station 110 may not be transmitting SSBs and a CSI-RS to the same UE 110 at a PSM periodicity. Base station 122 may also be a SCG 220 to another UE 110 (at 3.3). In such scenarios, base station 122 may transmit a reference signal, with SSBs and a CSI-RS, to UE 110 in accordance with a PSM periodicity instead of a reference signal, with SSBs and a CSI-RS, with the active mode periodicity.

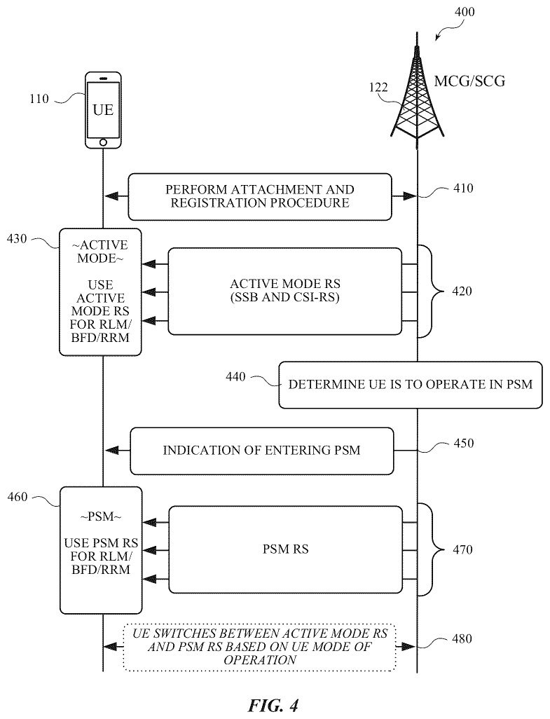

FIG. 4 is a diagram of an example of a process 400 for implementing enhanced power saving according to one or more implementations described herein. Process 400 may be implemented by UE 110 and base station 122. In some implementations, some or all of process 400 may be performed by one or more other systems or devices, including one or more of the devices of FIG. 1 or 2. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or process depicted in FIG. 4. In some implementations, base station 122 may be part of an MSG and/or SCG to UE 110. Additionally, an implementation involving one or more of the operations of process 400 may include one or more operations or functions described herein.

As shown, process 400 may include UE 110 and base station 122 performing an attachment and registration procedure (at 410). This may include UE 110 discovering base station 122, determining channels for communicating with base station 122, and exchanging information with base station 122 to establish a connection between UE 110 and base station 122. In some implementations, UE 110 and/or base station 122 may provide the other with an indication of whether the other is configured for reduced or relaxed reference signals (e.g., PSM reference signals). This may occur during and/or after attachment and registration. Upon attaching to the network, UE 110 may operate in an active mode to send and receive information from base station 122.

While in active mode, base station 122 may communicate reference signals to UE 110 according to a particular periodicity (e.g., an active mode periodicity) (at 420). UE 110 may receive the reference signals from base station 122 and may perform one or more of RLM, BFD, and RRM based on the reference signals. The reference signals may include SSBs, a CSI-RS, and/or one or more additional types of information for performing RLM, BFD, and RRM. In some implementations, UE 110 may take one or more measurements of the reference signals from base station 122 and communicate the measurements and other information to base station 122.

Base station 122 may determine that UE 110 is to enter PSM (at 440). For example, base station 122 may detect or determine a condition for UE 110 to transition from an active mode of operation to a PSM of operation. Examples of such conditions may include determining that UE 110 is located near an edge of a cell range of base station 122 or that UE 110 is stationary or having low mobility. In scenarios in which base station 122 is part of an SCG 222, the condition may include the SCG being deactivated, or a BWP used for transmitting a reference signal, at an active mode periodicity, going dormant. Base station 122 may communicate an indication, to UE 110, to ender PSM (at 450). In some implementations, this may include one or more RRC messages, which may include one or more IEs. In some implementations, base station 122 may explicitly indicate a transition to a PSM reference signal (e.g., via RRC message). In some implementations, the transition to PSM reference signals may be implicit (e.g., based on measurements of UE 110 being near an edge of the cell range of base station 122, a change in BWP, the SCG being deactivated, etc). In some implementations, base station 122 may also, or alternatively, indicate details about the PSM reference signals, such as a periodicity and other resources to be used for the PSM reference signals. In some implementations, UE 110 may determine to enter PSM and may notify base station 122 of the transition to PSM. In response, base station 122 may determine an appropriate PSM RF (e.g., an appropriate RF periodicity) and provide the PSM RF information to UE 110.

UE 110 may enter a PSM (at 460). In some implementations, UE 110 may transition to a PSM by switching from reference signals communicated at a higher periodicity (e.g., an active mode periodicity) to reference signals with a lower periodicity (e.g., a PSM periodicity). In some implementations, base station 122 may also transition to a PSM (at 470). For example, base station 122 may enter a PSM (with respect to UE 110) by transmitting reference signals for RLM, BFD, and RRM at a lower periodicity. In some implementations, base station 122 and UE 110 may revert back to a reference signal with a higher periodicity upon determining a suitable condition, detecting a certain trigger, etc., which may include a previously deactivated SCG being reactivated, a previously dormant BWP leaving dormancy, etc. (block 480). In some implementations, UE 110 may be configured to concurrently monitor reference signals in an active mode of operation and a PSM of operation. For example, UE 110 may be configured to operating in an active mode to monitor a reference signal from a base station of an MCG while operating in a PSM to monitor a reference signal from a base station of a SCG.

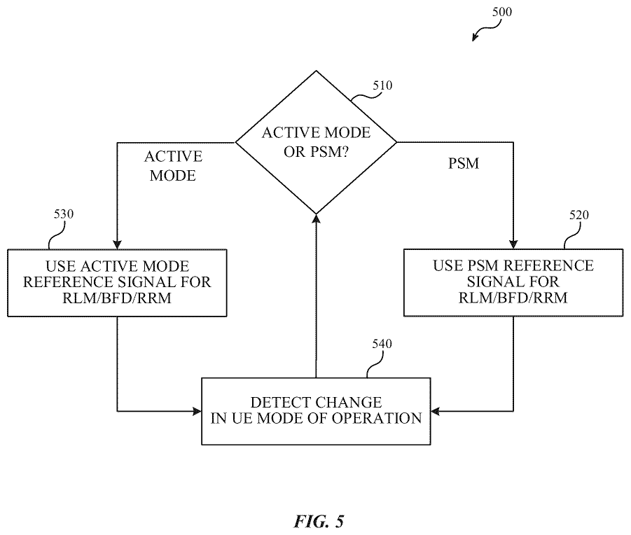

FIG. 5 is a diagram of an example of a process 500 for implementing enhanced power saving at a UE. Process 500 may be implemented by UE 110 and/or base station 122. In some implementations, some or all of process 500 may be performed by one or more other systems or devices, including one or more of the devices of FIG. 1 or 2. Additionally, process 500 may include one or more fewer, additional, differently ordered and/or arranged operations than those shown in FIG. 5. In some implementations, some or all of the operations of process 500 may be performed independently, successively, simultaneously, etc., of one or more of the other operations of process 500. As such, the techniques described herein are not limited to a number, sequence, arrangement, timing, etc., of the operations or process depicted in FIG. 5. Additionally, an implementation involving one or more of the operations of process 500 may include one or more operations or functions described herein.

Process 500 may include determining whether UE 110 is in an active mode of operation or a PSM of operation (block 510). For example, UE 110 may determine whether to operate in an active mode or a PSM based on one or more implicit or explicit conditions. Examples of an implicit condition may include a state or condition of UE 110, base station 122, and/or resources that UE 110 and base station 122 may use to communicate with one another. For instance, base station 122 operating as a SCG to UE 110

UE 110 may implicitly determine to transition to a PSM when base station 122 is operating as a SCG and is deactivated or a BWP is switched from active to dormant. A dormant BWP may include a state where UE 110 is not active or is less active (e.g., a state where UE 110 does not use bandwidth or minimally schedules use of bandwidth). UE 110 may continue monitoring a DL control channel on a PCell but may skip DL control channel monitoring or reduce DL control channel monitoring on at least one SCell. A signaling mechanism to put the SCell(s) in and out of the dormant state (e.g., switching between an active BWP and a dormant BWP) may be accomplished in several ways. In some implementations, the SCell may transition between the dormant state and the active state based on the BWP status of the primary cell (e.g., PCell or PSCell).

UE 110 may explicitly determine to transition to a PSM when, for example, UE 110 receives instructions, an indication, or other information, from base station 122, prompting UE 110 to transition to a PSM. Examples of such information may include RRC messages, IEs, and parameters indicating an increased periodicity for reference signals used for RLM, BFM, and RRM. Examples of such information are discussed in greater detail below.

When UE 110 is to transition to a PSM of operation (block 510—PSM), process 500 may including using a PSM reference signal for RML, BFD, and/or RRM (block 520). For example, UE 110 may transition from monitoring a reference signal with a higher periodicity to monitoring a reference signal with a lower periodicity. When UE 110 is to transition to an active mode of operation (block 510—Active Mode), process 500 may including using an active mode reference signal for RLM, BFD, and/or RRM (block 530). For example, UE 110 may transition from monitoring a reference signal with a lower periodicity (e.g., a PSM reference signal) to monitoring a reference signal with a higher periodicity (e.g., an active mode reference signal).

Process 500 may also include detecting a change in a mode of operation of UE 110 (block 540). For example, whether UE 110 is operating in an active mode or a PSM, UE 110 may receive an indication, which may be implicit or explicit, to change from an active mode of operation to a PSM of operation or vice versa. As discussed herein, the indication may be implicit or explicit. An implicit indication may include a change in a state or condition of UE 110, base station 122, and/or resources that UE 110 and base station 122 may use to communicate with one another, (e.g., base station 122 being activated/deactivated, a BWP being active or dormant, whether UE 110 has low mobility or high mobility, whether UE is near a cell edge, etc.). An explicit indication may include instructions, an indication, or other information that UE 110 may receive from base station 122. As shown, upon detecting a change in a mode of operation of UE 110 (block 540), process 500 may proceed by determining whether UE 110 is to operate in an active mode or a PSM (block 510) and use a corresponding reference signal for RLM, BFD, and/or RRM. In some implementations, UE 110 may be configured to concurrently monitor reference signals in an active mode of operation and a PSM of operation. For example, UE 110 may be configured to operating in an active mode to monitor a reference signal from a base station of an MCG while operating in a PSM to monitor a reference signal from a base station of a SCG.

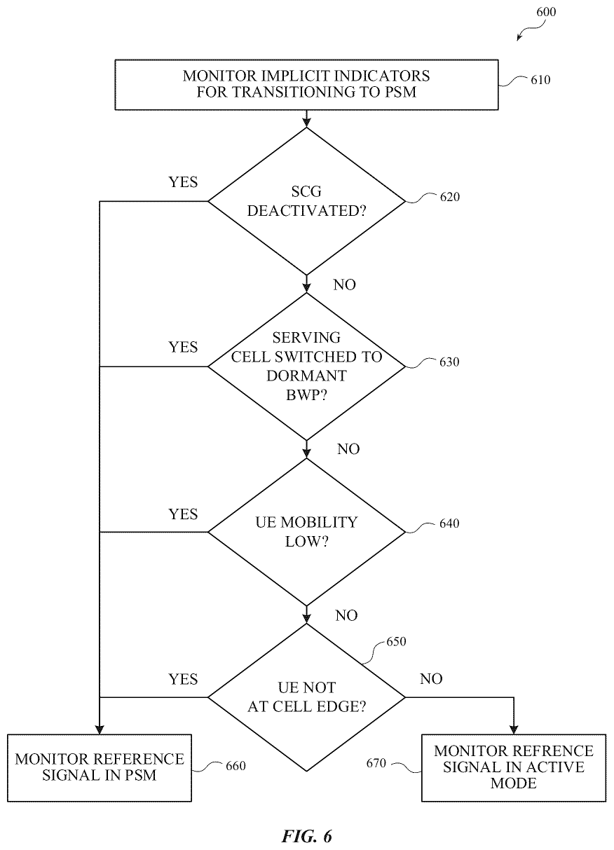

FIG. 6 is a diagram of an example of a process 600 for determining conditions for implementing enhanced power saving. Process 600 may be implemented by UE 110 and/or base station 122. In some implementations, some or all of process 600 may be performed by one or more other systems or devices, including one or more of the devices of FIG. 1 or 2. Additionally, process 600 may include one or more fewer, additional, differently ordered and/or arranged operations than those shown in FIG. 6. In some implementations, some or all of the operations of process 600 may be performed independently, successively, simultaneously, etc., of one or more of the other operations of process 600. As such, the techniques described herein are not limited to a number, sequence, arrangement, timing, etc., of the operations or process depicted in FIG. 6. Additionally, an implementation involving one or more of the operations of process 600 may include one or more operations or functions described herein. For example, process 600 may include or be preceded by a determination (by UE 110) of whether a serving cell or a frequency range is capable of a PSM by communicating relaxed, or lower periodicity, reference signals.

Process 600 may include monitoring implicit indicators for transitioning to PSM (block 610). For example, while in an active mode of operation, UE 110 may monitor one or more conditions, such as activation, deactivation, or reactivation of a base station operating as a MCG or SCG for UE 110, changes in a BWP used to communicate with UE 110, a degree of mobility of UE 110, whether UE 110 is located at an edge of a cell of base station 122, or one or more other conditions, configurations, or situations associated with UE 110 operating in a PSM. In some implementations, UE 110 may be configured to monitor one condition, multiple conditions, or conditions according to a hierarchy is significance, etc.

Process 600 may include determining whether a base station of an SCG for UE 110 has been deactivated (block 620). For example, while in an active mode of operation UE 110 may be sending and receiving information from MCG 210 and SCG 220, which may include one or more base stations 122. While UE 110, MCG 210 and SCG 220 are communicating actively, UE 110 may monitor reference signals from each of MCG 210 and SCG 220 actively (e.g., with a relatively high periodicity). When communications between UE 110 and the network decline, SCG 220 may transition from an activated state to a deactivated (or idle or inactive) state for UE 110. In such a scenario, UE 110 may continue active monitoring of the reference signal from MCG 210 but transition to a PSM type of monitoring of the reference signal from SCG 220 (block 660). In some implementations, UE 110 may have received instructions and/or information for PSM monitoring of the SCG 220 when attaching to the network, while actively communicating with the network, and/or in combination with a notification that SCG 220 was being deactivated.

Process 600 may include determining whether a BWP of a serving cell (e.g., base station 122) has become dormant (block 630). A dormant BWP may include a state where UE 110 is not active or is less active (e.g., a state where UE 110 does not use bandwidth or minimally schedules use of bandwidth). UE 110 may continue monitoring a DL control channel on a PCell but may skip DL control channel monitoring or reduce DL control channel monitoring on at least one SCell. A signaling mechanism to put the SCell(s) in and out of the dormant state (e.g., switching between an active BWP and a dormant BWP) may be accomplished in several ways. In some implementations, the SCell may transition between the dormant state and the active state based on the BWP status of the primary cell (e.g., PCell or PSCell). When the BWP of the serving cell has become dormant (block 630—Yes), process 600 may proceed with monitoring a reference signal from the serving cell in a PSM (block 660). In such scenarios, UE 110 may continue to actively monitor the reference signals of non-dormant BWPs, such that active connections may be monitored in an active manner while less active connections may be monitored in a way to helps conserve power. When the BWP of the serving cell has not become dormant (block 630—No), process 600 may proceed with determining whether a mobility of UE 110 is low (block 640). For example, UE 110 may determine a level of mobility of the UE. Low mobility may be determined when the following is true:
(SrxlevRef−Srxlev)<S_{SearchDeltaP}, where:
Srxlev is a current cell selection reception (Rx) level (in dB) of the serving cell;
SrxlevRef is a reference Srxlev value of the serving cell (in dB); and
S_{SearchDeltaP} is a threshold (in dB) on Srxlev variation for relaxed measurement.

Additionally, UE 110 may be configured to implement this as follows. After selection or reselection of a new cell, if (Srxlev−SrxlevRef)>0, or if the relaxed measurement criterion has not been met for T_{SearchDeltaP} (i.e., the time period over which the Srxlev variation is evaluated for relaxed measurement, UE 110 may set the value of SrxlevRef to the current Srxlev value of the serving cell.

When the mobility of UE 110 is low (block 640—Yes), process 600 may proceed with monitoring a reference signal from the serving cell in a PSM (block 660). When the mobility of UE 110 is not low (block 640—No), process 600 may proceed with determining whether UE 110 is located near an edge of the serving cell (block 650). For example, UE 110 may determine whether UE 110 is located near an edge of a cell range of a base station to which UE 110 is connected. In some implementations, UE 110 may determine that the UE is not near the cell edge when the following is true:
Srxlev>S_{SearchThresholdP}, and,
Squal>S_{SearchThresholdQ}, if S_{SearchThresholdQ} is configured, where:
Srxlev is a current cell selection reception (Rx) level value (in dB) of the serving cell;
S_{SearchThresholdP} is the Srxlev threshold (in dB) for relaxed measurement;
Squal is a current cell selection quality value (in dB) of the serving cell (dB); and
S_{SearchThresholdQ} is a Squal threshold (in dB) for relaxed measurement;

When UE 110 is not located near an edge of the serving cell (block 650—Yes), process 600 may proceed with monitoring a reference signal from the serving cell in a PSM (block 660). When UE 110 is located near an edge of the serving cell (block 650—No), process 600 may proceed with monitoring a reference signal from the serving cell in an active mode (block 670).

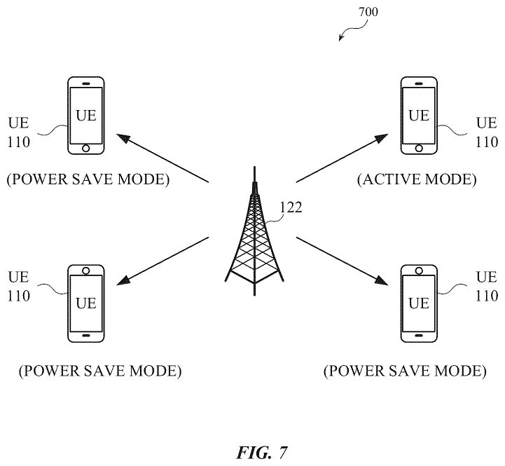

FIG. 7 is a diagram of example 700 of UE-specific implementation of enhanced power saving according to one or more implementations described herein. As shown, multiple UEs 110 may be connected to base station 122. In some implementations, base station 122 may be operating as a node of MCG 210 or a node of SCG 220. In some implementations, base station 122 may be part of MCG 210 for some UEs 110 and part of SCG 220 for other UEs 110. Additionally, or alternatively, some UEs 110 may be monitoring an active reference signal from base station 122 while other UEs 110 may be monitoring a PSM reference signal. Each group of UEs 110 may monitor and measure the reference signals for RLM, BFD, and RRM purposes; however, UEs 110 may be performing a relaxed or power saving version of RLM, BFD, and RRM due to, for example, the reduced periodicity of PSM reference signals. As such, the power saving techniques described herein may be applied on a UE-specific basis.

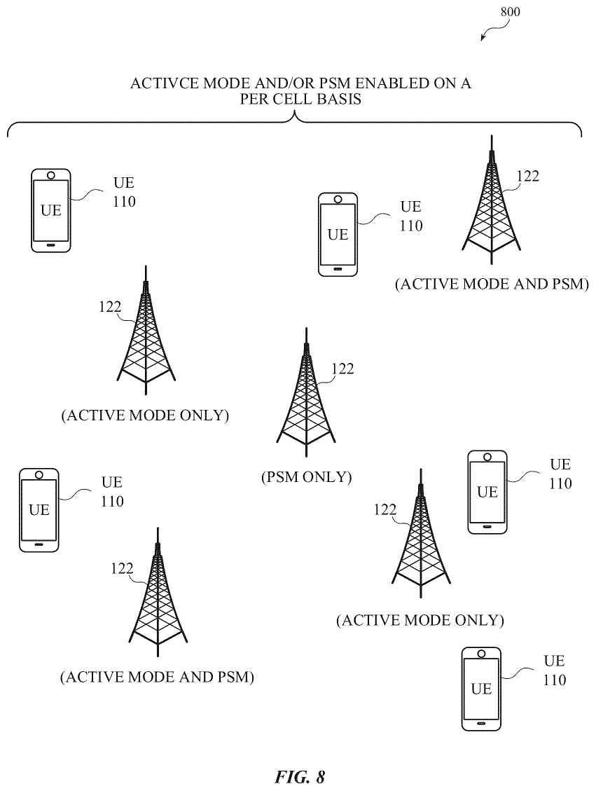

FIG. 8 is a diagram of example 800 of a cell-specific implementation of enhanced power saving according to one or more implementations described herein. As shown, a wireless network may include multiple base stations 122, each of which may operate as part of a MCG, a SCG, or a combination thereof. Additionally, some base stations 122 may be configured to operate (e.g., participate in RLM, BFD, and RRM) in accordance with the active mode signaling described herein, a PSM reference signaling described herein, or a combination thereof. In some implementations, base stations 122 may be configured to indicate to UEs 110 whether the base station (or cell group) is capable of supporting PSM reference signaling. In some implementations, each base station 122 may provide this information (e.g., via RRC messaging) to UEs 110 upon initial attachment and registration, during active communication, or at another time. As such, prior to determining whether UE 110 is to transition to a PSM, UE 110 may be configured to determine whether the serving cell can accommodate a PSM of operation (e.g., by providing relaxed, or less-frequent, reference signals upon which UE 110 may perform or participate in RLM, BFD, and RRM).

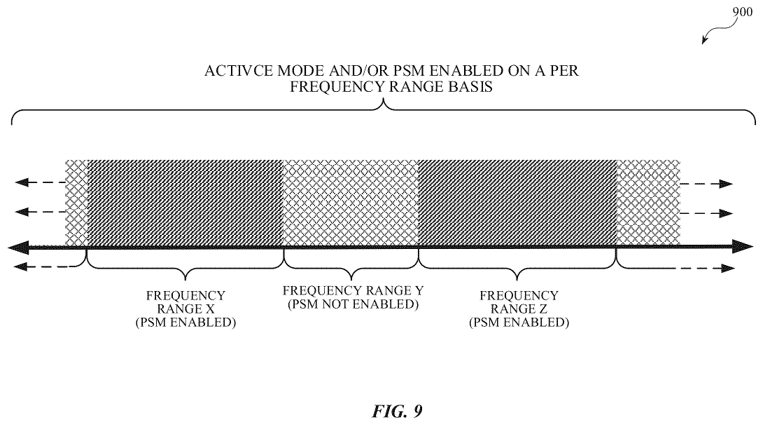

FIG. 9 is a diagram of example 900 of a frequency-specific implementation of enhanced power saving according to one or more implementations described herein. As shown, example 900 may include several frequency ranges (e.g., frequency range X, frequency range Y, frequency Z, and so on). The techniques described herein include the capability of specifying certain frequency ranges that are configured for relaxed, or PSM, transmission of reference signals for RLM, BFD, and RRM. In some implementations, base station 122 may be configured to indicate to UEs 110 which frequency ranges are capable of supporting PSM reference signaling. In some implementations, base station 122 may provide this information (e.g., via RRC messaging) to UEs 110 upon initial attachment and registration, during active communication, or at another time. As such, prior to determining whether UE 110 is to transition to a PSM, UE 110 may be configured to determine whether a reference signal transmitted by base station 122 can accommodate a PSM of operation (e.g., by providing relaxed, or less-frequent, reference signals upon which UE 110 may perform or participate in RLM, BFD, and RRM).

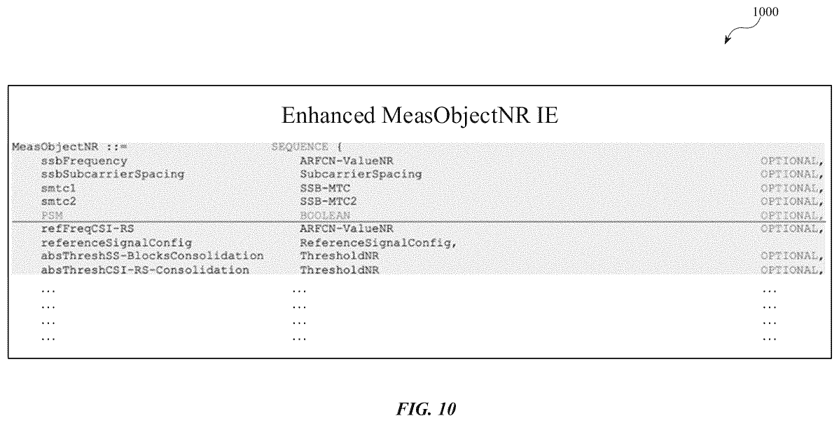

FIGS. 10-18 are diagrams of examples 1000, 1100, . . . 1800 (referred to collectively as “examples 1000-1800”) of enhanced RRC IEs for implementing enhanced power saving according to one or more implementations described herein. In some implementations, examples 1000-1800 may represent ways in which one or more of the enhanced power saving techniques, described herein, may be integrated within one or more existing 3GPP processes, IEs, RRC messages, etc. The following description does not describe all instructions and parameters of the IEs but instead highlights the enhancements to the IEs that may enable the techniques described herein.

As such, base station 122 and UE 110 may use one or more of the example IEs of FIGS. 10-18 to implement the enhanced power saving techniques described herein. In other implementations, base station 122 and UE 110 may use one or more additional, alternative, or differently arranged IEs. As such, the IEs of FIGS. 10-18 are provided as non-limiting examples of the scope of the techniques described herein. Indeed, some of FIGS. 10-18 may illustrate an IE (e.g., an enhanced MeasObjectNR IE) as having a PSM Boolean parameter whereas other figures may illustrate the same IE has having a non-Boolean value.

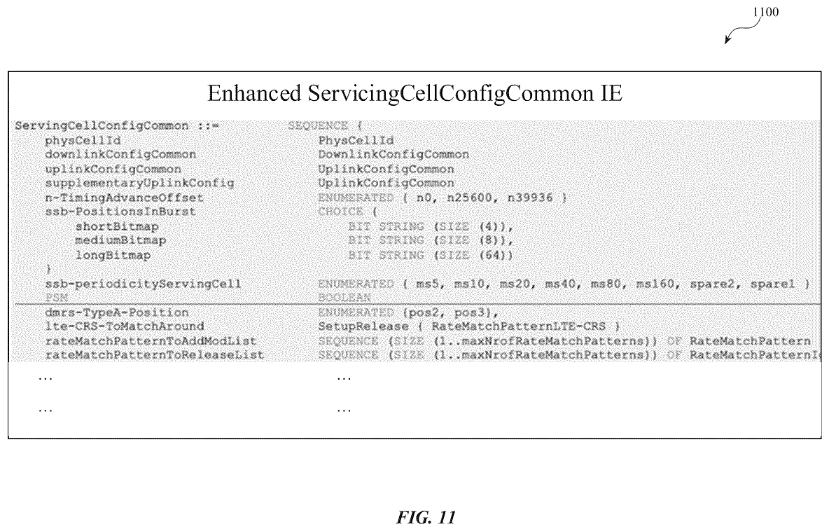

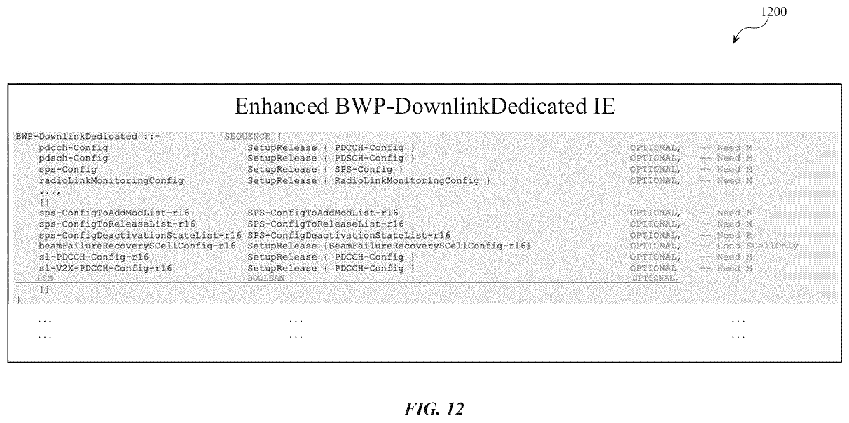

As shown in FIG. 10, an enhanced MeasObjectNR IE may include a Boolean parameter for PSM. Base station 122 may communicate the enhanced MeasObjectNR IE to UE 110 as an instruction or indication of whether UE 110 is to monitor or measure a reference object (e.g., a reference signal) in accordance with an active mode or a PSM—as indicated by the Boolean value. As shown in FIG. 11, an enhanced ServicingCellConfigCommon IE may include a Boolean parameter for PSM. Base station 122 may communicate the enhanced ServicingCellConfigCommon IE to UE 110 as an instruction or indication of whether base station 122 is configured to support PSM monitoring. In some implementations, such an indication may enable UE 110 to determine whether a PSM may be implied based on a UE, base station, or other condition. As shown in FIG. 12, an enhanced BWP-DownlinkDedicated IE may include a Boolean parameter for PSM. Base station 122 may communicate the enhanced BWP-DownlinkDedicated IE to UE 110 as an instruction or indication of whether a particular BWP (e.g., a frequency range) is configured to support PSM monitoring.

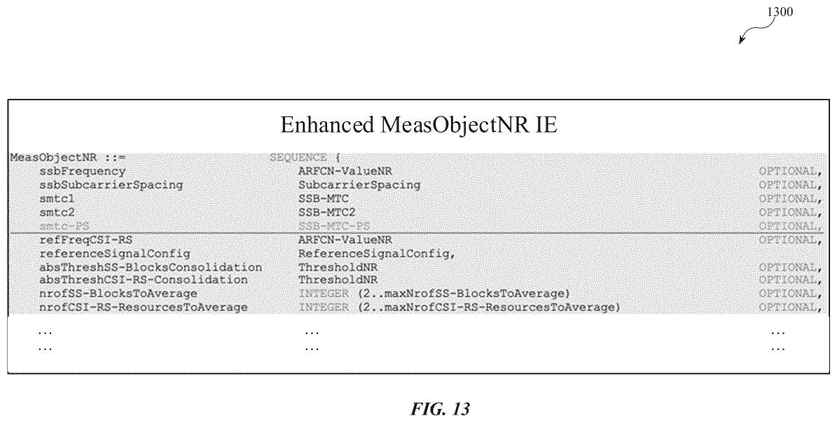

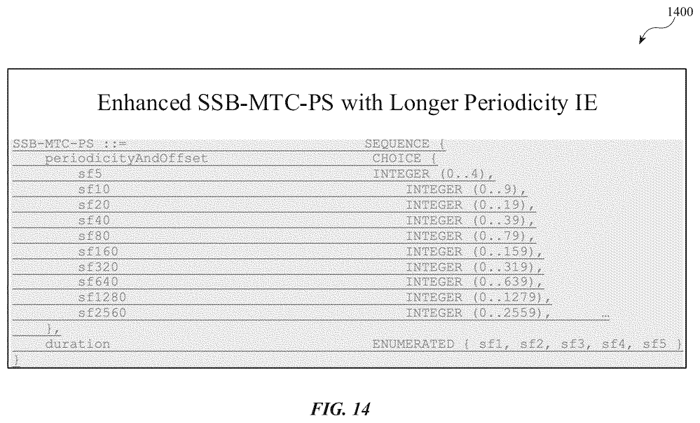

As shown in FIG. 13, an enhanced MeasObjectNR IE may include a smtc-PS parameter with a value set to SSB-MTC-PS. FIG. 14 includes examples of a list of SSB-MTC-PS values (e.g., sf5, sf10, . . . sf2560) that may correspond to a periodicityAndOffset for PSM monitoring (e.g., a periodicity that is less than active mode or legacy periodicities). In some implementations, base station 122 may communicate the enhanced MeasObjectNR IE to UE 110 as an instruction or indication of whether UE 110 to begin PSM monitoring and/or the extended periodicity for PSM monitoring.

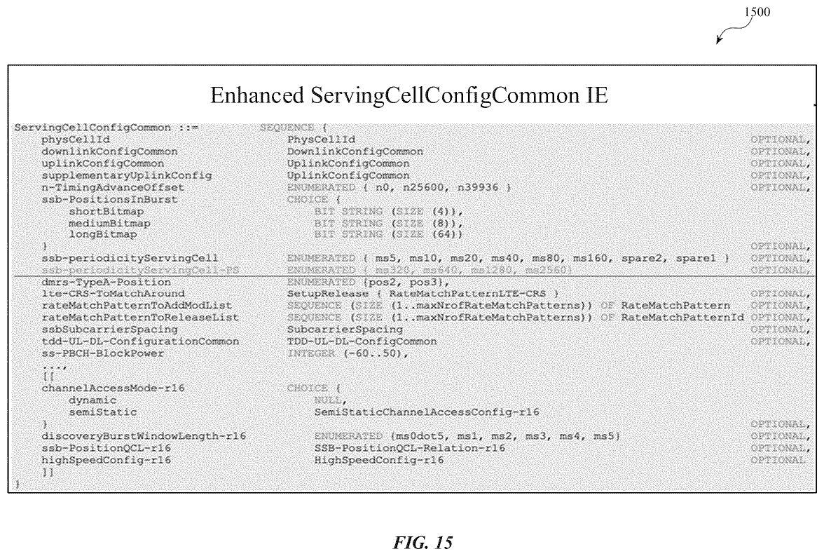

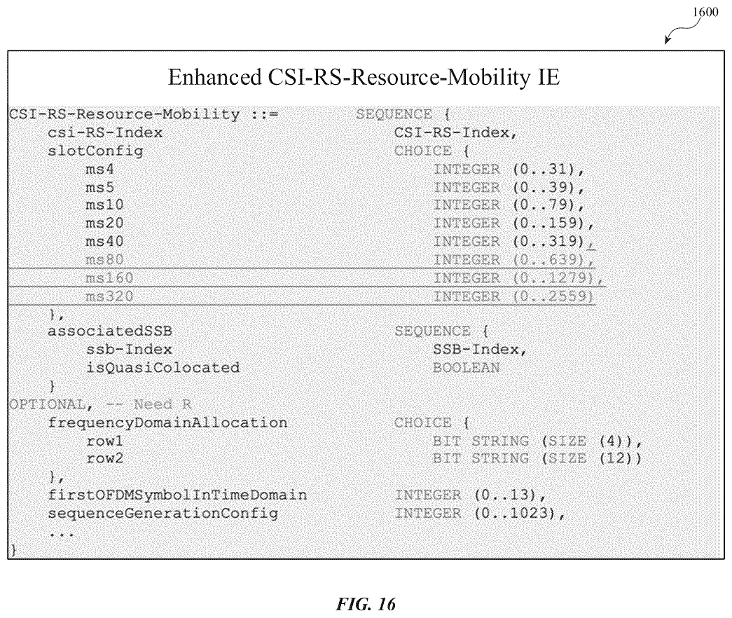

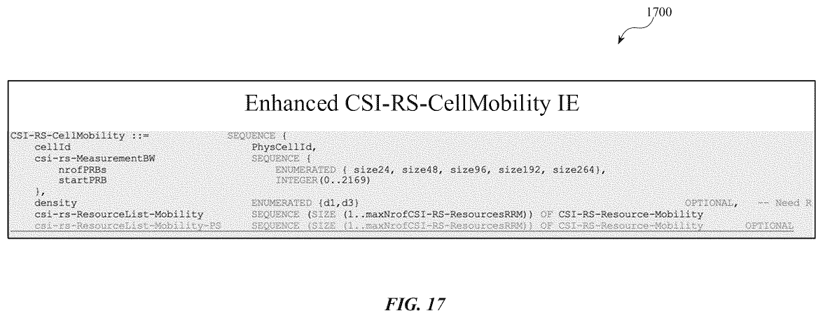

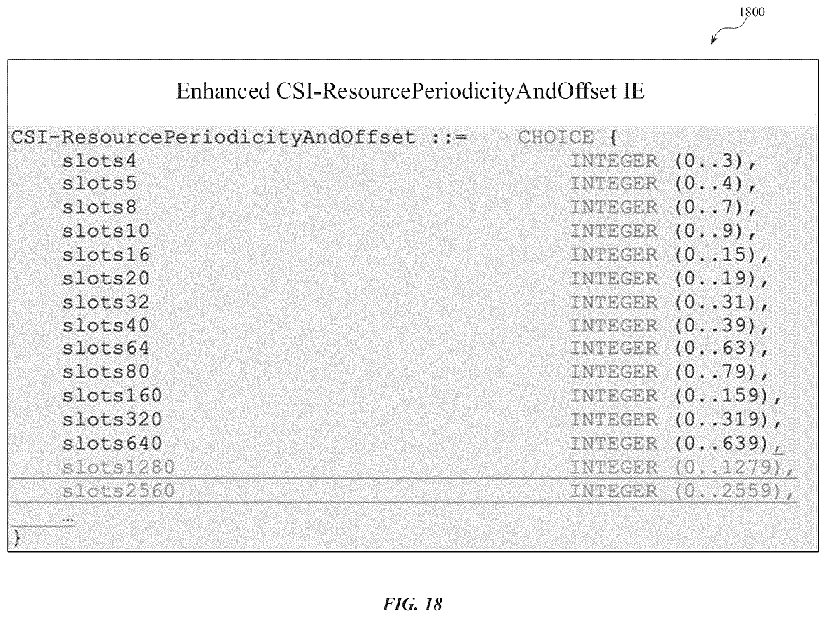

As shown in FIG. 15, an enhanced ServicingCellConfigCommon IE may include a ssb-periodictiyServingCell-PS parameter, which may be enumerated as ms320, ms640, etc. In FIG. 16, an enhanced CSI-RS-Resource-Mobility IE may include slot configuration (slotConfig) values for active or legacy reference signal monitoring, in addition to power saving slot configuration values, such as ms80, ms160, ms320, and so on, referring to possible values for the ssb-periodictiyServicCell-PS parameter of the enhanced ServicingCellConfigCommon IE of FIG. 15. FIG. 17 may include an enhanced CSI-RS-Resource-Mobility IE with a csi-rs-ResourceList-Mobility-PS parameter referencing CSI-RS resources for PSM monitoring. And FIG. 18 may include an enhanced CSI-ResourcePeriodicityAndOffset IE with periodicity and offset slot values (e.g., slots4, slots5, etc.) for active or legacy reference signal monitoring in addition to periodicity and offset slot values (e.g., slots1280, slots2560, etc.) for PSM signal monitoring.

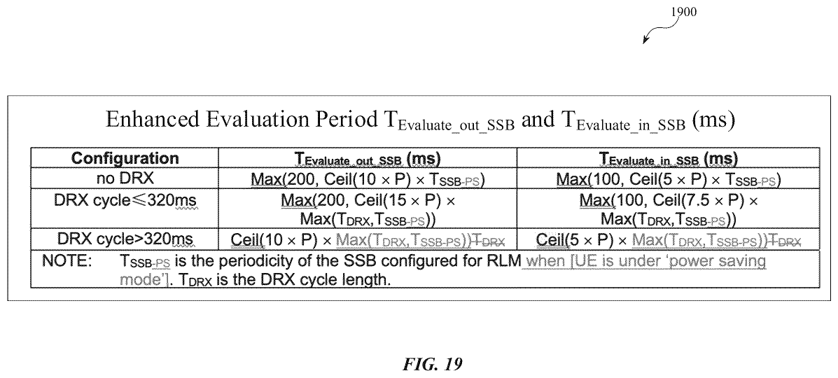

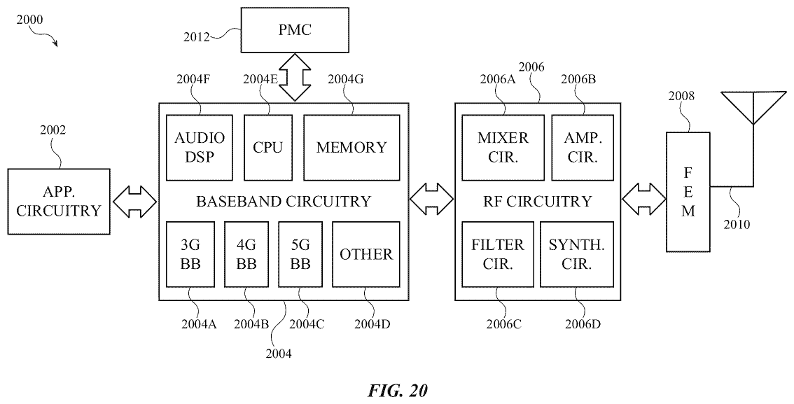

FIG. 19 is a diagram of an example 1900 table for implementing enhanced power saving during discontinuous reception (DRX) according to one or more implementations described herein. The power saving may be achieved by adjusting the evaluation period of RLM and/or BFD. The adjusted evaluation period may be calculated based on a periodicity of a PSM reference signals as indicated in example 1900 and described herein. As illustrated in FIG. 19, the techniques described herein may be implemented using an extended periodicity parameter for time (TSSB-PS), which may be modified by a function of a maximum of time based on a DRX time (TDRX) and TSSB-PS. FIGS. 20-22 are examples of devices, modules, interfaces, and/or other functionally structural features that may be implemented to provide or enable one or more of the techniques described herein. One skilled in the art will appreciate that the functionally structural features may vary based on the implementation.

FIG. 20 is a diagram of an example of components of a device according to one or more implementations described herein. In some implementations, the device 2000 can include application circuitry 2002, baseband circuitry 2004, RF circuitry 2006, front-end module (FEM) circuitry 2008, one or more antennas 2010, and power management circuitry (PMC) 2012 coupled together at least as shown. The components of the illustrated device 2000 can be included in a UE or a RAN node. In some implementations, the device 2000 can include fewer elements (e.g., a RAN node may not utilize application circuitry 2002, and instead include a processor/controller to process IP data received from a CN such as 5GC 130 or an Evolved Packet Core (EPC)). In some implementations, the device 2000 can include additional elements such as, for example, memory/storage, display, camera, sensor (including one or more temperature sensors, such as a single temperature sensor, a plurality of temperature sensors at different locations in device 2000, etc.), or input/output (I/O) interface. In other implementations, the components described below can be included in more than one device (e.g., said circuitries can be separately included in more than one device for Cloud-RAN (C-RAN) implementations).

The application circuitry 2002 can include one or more application processors. For example, the application circuitry 2002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 2000. In some implementations, processors of application circuitry 2002 can process IP data packets received from an EPC.

The baseband circuitry 2004 can include circuitry such as, but not limited to, one or more single-core or multi-core processors. The baseband circuitry 2004 can include one or more baseband processors or control logic to process baseband signals received from a receive signal path of the RF circuitry 2006 and to generate baseband signals for a transmit signal path of the RF circuitry 2006. Baseband circuitry 2004 can interface with the application circuitry 2002 for generation and processing of the baseband signals and for controlling operations of the RF circuitry 2006. For example, in some implementations, the baseband circuitry 2004 can include a 3G baseband processor 2004A, a 4G baseband processor 2004B, a 5G baseband processor 2004C, or other baseband processor(s) 2004D for other existing generations, generations in development or to be developed in the future (e.g., 2G, 6G, etc.). The baseband circuitry 2004 (e.g., one or more of baseband processors 2004A-D) can handle various radio control functions that enable communication with one or more radio networks via the RF circuitry 2006. In other implementations, some or all of the functionality of baseband processors 2004A-D can be included in modules stored in the memory 2004G and executed via a Central Processing Unit (CPU) 2004E. The radio control functions can include, but are not limited to, signal modulation/demodulation, encoding/decoding, radio frequency shifting, etc. In some implementations, modulation/demodulation circuitry of the baseband circuitry 2004 can include Fast-Fourier Transform (FFT), precoding, or constellation mapping/de-mapping functionality. In some implementations, encoding/decoding circuitry of the baseband circuitry 2004 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 2004 can include one or more audio digital signal processor(s) (DSP) 2004F. The audio DSPs 2004F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 2004 and the application circuitry 2002 can be implemented together such as, for example, on a system on a chip (SOC).

In some implementations, the baseband circuitry 2004 can provide for communication compatible with one or more radio technologies. For example, in some implementations, the baseband circuitry 2004 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 2004 is configured to support radio communications of more than one wireless protocol can be referred to as multi-mode baseband circuitry.

RF circuitry 2006 can enable communication with wireless networks using modulated electromagnetic radiation through a non-solid medium. In various implementations, the RF circuitry 2006 can include switches, filters, amplifiers, etc. to facilitate the communication with the wireless network. RF circuitry 2006 can include a receive signal path which can include circuitry to down-convert RF signals received from the FEM circuitry 2008 and provide baseband signals to the baseband circuitry 2004. RF circuitry 2006 can also include a transmit signal path which can include circuitry to up-convert baseband signals provided by the baseband circuitry 2004 and provide RF output signals to the FEM circuitry 2008 for transmission.

In some implementations, the receive signal path of the RF circuitry 2006 can include mixer circuitry 2006A, amplifier circuitry 2006B and filter circuitry 2006C. In some implementations, the transmit signal path of the RF circuitry 2006 can include filter circuitry 2006C and mixer circuitry 2006A. RF circuitry 2006 can also include synthesizer circuitry 2006D for synthesizing a frequency for use by the mixer circuitry 2006A of the receive signal path and the transmit signal path. In some implementations, the mixer circuitry 2006A of the receive signal path can be configured to down-convert RF signals received from the FEM circuitry 2008 based on the synthesized frequency provided by synthesizer circuitry 2006D. The amplifier circuitry 2006B can be configured to amplify the down-converted signals and the filter circuitry 2006C can be a low-pass filter (LPF) or band-pass filter (BPF) configured to remove unwanted signals from the down-converted signals to generate output baseband signals. Output baseband signals can be provided to the baseband circuitry 2004 for further processing. In some implementations, the output baseband signals can be zero-frequency baseband signals, although this is not a requirement. In some implementations, mixer circuitry 2006A of the receive signal path can comprise passive mixers, although the scope of the implementations is not limited in this respect.

In some implementations, the mixer circuitry 2006A of the transmit signal path can be configured to up-convert input baseband signals based on the synthesized frequency provided by the synthesizer circuitry 2006D to generate RF output signals for the FEM circuitry 2008. The baseband signals can be provided by the baseband circuitry 2004 and can be filtered by filter circuitry 2006C.

In some implementations, the mixer circuitry 2006A of the receive signal path and the mixer circuitry 2006A of the transmit signal path can include two or more mixers and can be arranged for quadrature down conversion and up conversion, respectively. In some implementations, the mixer circuitry 2006A of the receive signal path and the mixer circuitry 2006A of the transmit signal path can include two or more mixers and can be arranged for image rejection (e.g., Hartley image rejection). In some implementations, the mixer circuitry 2006A of the receive signal path and the mixer circuitry′ 2006A can be arranged for direct down conversion and direct up conversion, respectively. In some implementations, the mixer circuitry 2006A of the receive signal path and the mixer circuitry 2006A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 2006 can include analog-to-digital converter (ADC) and digital-to-analog converter (DAC) circuitry and the baseband circuitry 2004 can include a digital baseband interface to communicate with the RF circuitry 2006.

In some dual-mode implementations, a separate radio IC circuitry can be provided for processing signals for each spectrum, although the scope of the implementations is not limited in this respect.

In some implementations, the synthesizer circuitry 2006D can be a fractional-N synthesizer or a fractional N/N+1 synthesizer, although the scope of the implementations is not limited in this respect as other types of frequency synthesizers can be suitable. For example, synthesizer circuitry 2006D can be a delta-sigma synthesizer, a frequency multiplier, or a synthesizer comprising a phase-locked loop with a frequency divider.

The synthesizer circuitry 2006D can be configured to synthesize an output frequency for use by the mixer circuitry 2006A of the RF circuitry 2006 based on a frequency input and a divider control input. In some implementations, the synthesizer circuitry 2006D can be a fractional N/N+1 synthesizer.

In some implementations, frequency input can be provided by a voltage controlled oscillator (VCO), although that is not a requirement. Divider control input can be provided by either the baseband circuitry 2004 or the applications circuitry 2002 depending on the desired output frequency. In some implementations, a divider control input (e.g., N) can be determined from a look-up table based on a channel indicated by the applications circuitry 2002.

Synthesizer circuitry 2006D of the RF circuitry 2006 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 2006D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 2006 can include an IQ/polar converter.

FEM circuitry 2008 can include a receive signal path which can include circuitry configured to operate on RF signals received from one or more antennas 2010, amplify the received signals and provide the amplified versions of the received signals to the RF circuitry 2006 for further processing. FEM circuitry 2008 can also include a transmit signal path which can include circuitry configured to amplify signals for transmission provided by the RF circuitry 2006 for transmission by one or more of the one or more antennas 2010. In various implementations, the amplification through the transmit or receive signal paths can be done solely in the RF circuitry 2006, solely in the FEM circuitry 2008, or in both the RF circuitry 2006 and the FEM circuitry 2008.

In some implementations, the FEM circuitry 2008 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 2006). The transmit signal path of the FEM circuitry 2008 can include a power amplifier (PA) to amplify input RF signals (e.g., provided by RF circuitry 2006), and one or more filters to generate RF signals for subsequent transmission (e.g., by one or more of the one or more antennas 2010).

In some implementations, the PMC 2012 can manage power provided to the baseband circuitry 2004. In particular, the PMC 2012 can control power-source selection, voltage scaling, battery charging, or DC-to-DC conversion. The PMC 2012 can often be included when the device 2000 is capable of being powered by a battery, for example, when the device is included in a UE. The PMC 2012 can increase the power conversion efficiency while providing desirable implementation size and heat dissipation characteristics.

While FIG. 20 shows the PMC 2012 coupled only with the baseband circuitry 2004. However, in other implementations, the PMC 2012 may be additionally or alternatively coupled with, and perform similar power management operations for, other components such as, but not limited to, application circuitry 2002, RF circuitry 2006, or FEM circuitry 2008.

In some implementations, the PMC 2012 can control, or otherwise be part of, various power saving mechanisms of the device 2000. For example, if the device 2000 is in an RRC_Connected state, where it is still connected to the RAN node as it expects to receive traffic shortly, then it can enter a state known as Discontinuous Reception Mode (DRX) after a period of inactivity. During this state, the device 2000 can power down for brief intervals of time and thus save power.

If there is no data traffic activity for an extended period of time, then the device 2000 can transition off to an RRC_Idle state, where it disconnects from the network and does not perform operations such as channel quality feedback, handover, etc. The device 2000 goes into a very low power state and it performs paging where again it periodically wakes up to listen to the network and then powers down again. The device 2000 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 2002 and processors of the baseband circuitry 2004 can be used to execute elements of one or more instances of a protocol stack. For example, processors of the baseband circuitry 2004, alone or in combination, can be used execute Layer 3, Layer 2, or Layer 1 functionality, while processors of the baseband circuitry 2004 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

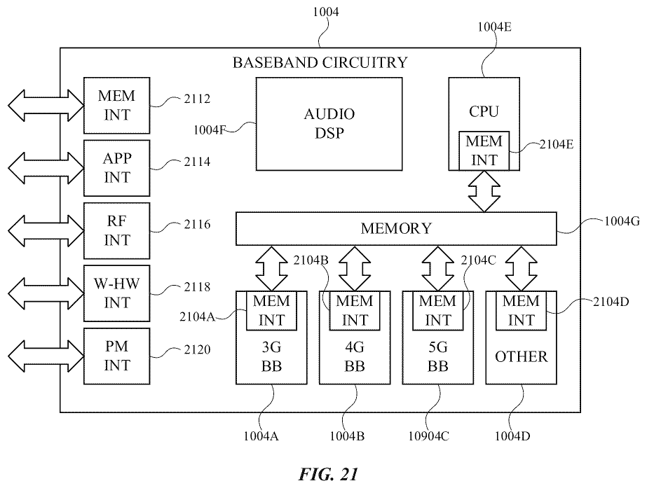

FIG. 21 is a diagram of example interfaces of baseband circuitry according to one or more implementations described herein. As discussed above, the baseband circuitry 2004 of FIG. 20 can comprise processors 2004A-2004E and a memory 2004G utilized by said processors. Each of the processors 2004A-2004E can include a memory interface, 2104A-2104E, respectively, to send/receive data to/from the memory 2004G.

The baseband circuitry 2004 can further include one or more interfaces to communicatively couple to other circuitries/devices, such as a memory interface 2112 (e.g., an interface to send/receive data to/from memory external to the baseband circuitry 2004), an application circuitry interface 2114 (e.g., an interface to send/receive data to/from the application circuitry 2002 of FIG. 20), an RF circuitry interface 2116 (e.g., an interface to send/receive data to/from RF circuitry 2006 of FIG. 20), a wireless hardware connectivity interface 2118 (e.g., an interface to send/receive data to/from Near Field Communication (NFC) components, Bluetooth® components (e.g., Bluetooth® Low Energy), Wi-Fi® components, and other communication components), and a power management interface 2120 (e.g., an interface to send/receive power or control signals to/from the PMC 2012).

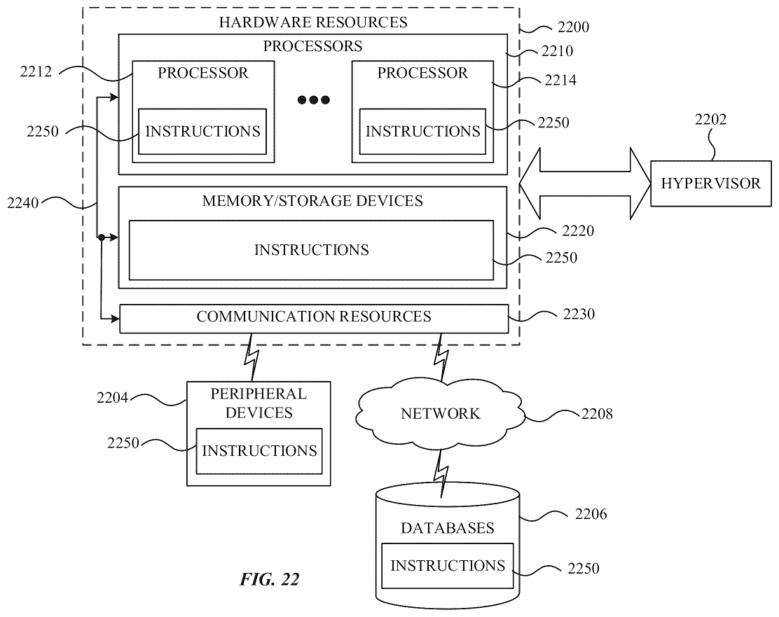

FIG. 22 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 22 shows a diagrammatic representation of hardware resources 2200 including one or more processors (or processor cores) 2210, one or more memory/storage devices 2220, and one or more communication resources 2230, each of which may be communicatively coupled via a bus 2240. For embodiments where node virtualization (e.g., NFV) is utilized, a hypervisor 2202 may be executed to provide an execution environment for one or more network slices/sub-slices to utilize the hardware resources 2200

The processors 2210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 2212 and a processor 2214.

The memory/storage devices 2220 may include main memory, disk storage, or any suitable combination thereof. The memory/storage devices 2220 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 2230 may include interconnection or network interface components or other suitable devices to communicate with one or more peripheral devices 2204 or one or more databases 2206 via a network 2208. For example, the communication resources 2230 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 2250 may comprise software, a program, an application, an applet, an app, or other executable code for causing at least any of the processors 2210 to perform any one or more of the methodologies discussed herein. The instructions 2250 may reside, completely or partially, within at least one of the processors 2210 (e.g., within the processor's cache memory), the memory/storage devices 2220, or any suitable combination thereof. Furthermore, any portion of the instructions 2250 may be transferred to the hardware resources 2200 from any combination of the peripheral devices 2204 or the databases 2206. Accordingly, the memory of processors 2210, the memory/storage devices 2220, the peripheral devices 2204, and the databases 2206 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the example described herein, a baseband processor of a UE may comprise: one or more processors configured to: operate in an active mode of operation by performing radio link monitoring (RLM) based on one or more reference signals, from a base station, with an increased periodicity; and transition from the active mode of operation to a power saving mode (PSM) of operation by performing the RLM based on one or more reference signals, from the base station, with a decreased periodicity.

In example 2, which may also include one or more of the examples described herein, wherein: the active mode of operation further includes performing beam failure detection (BFD) based on the one or more reference signals with the increased periodicity; and the PSM of operation further includes performing the BFD based on the one or more reference signals with the decreased periodicity. In example 3, which may also include one or more of the examples described herein, the active mode of operation further includes performing radio resource management (RRM) based on the one or more reference signals with the increased periodicity; and the PSM of operation further includes performing the BFD based on the one or more reference signals with the decreased periodicity.

In example 4, which may also include one or more of the examples described herein, the active mode of operation further comprises performing BFD and RRM based on one or more reference signals with an increased periodicity. In example 5, which may also include one or more of the examples described herein, the one or more reference signals with the increased periodicity includes system synchronizations blocks (SSBs), a channel state information (CSI) resource signal (CSI-RSs), or a combination of the SSBs and the CSI-RS; and the one or more reference signals with the decreased periodicity includes the SSBs, the CSI-RS, or the combination of the SSBs and the CSI-RS. In example 6, which may also include one or more of the examples described herein, the one or more processors may be configured to: prior to the transition from the active mode of operation to the PSM of operation, receive, from a base station, an explicit indication to transition from the active mode of operation to the PSM of operation; and transition to the PSM of operation in response to the indication to transition.

In example 7, which may also include one or more of the examples described herein, the explicit indication comprises a radio resource control (RRC) message with instructions to transition to the PSM of operation. In example 8, which may also include one or more of the examples described herein, the one or more processors may be configured to: prior to the transition from the active mode of operation to the PSM of operation, detect an implicit indication to transition to the PSM; and transition to the PSM of operation in response to the indication to transition. In example 9, which may also include one or more of the examples described herein, the implicit indication includes the base station, operating as a secondary cell group (SCG) node for the UE, being deactivated.

In example 10, which may also include one or more of the examples described herein, the implicit indication includes a base station, operating as a serving cell for the UE, switching to a dormant bandwidth part (BWP). In example 11, which may also include one or more of the examples described herein, the implicit indication includes the UE being a low mobility UE. In example 12, which may also include one or more of the examples described herein, the implicit indication includes the UE being located at a cell edge of a base station. In example 13, which may also include one or more of the examples described herein, the one or more processors may be configured to: prior to the transition from the active mode of operation to the PSM of operation, receive, from the base station, an indication that the base station supports the PSM of operation. In example 14, which may also include one or more of the examples described herein, the one or more reference signals with the increased periodicity may correspond to a same frequency range as the one or more reference signals with the decreased periodicity. In example 15, which may also include one or more of the examples described herein, the base station corresponds to a master cell group (MCG) or a SCG; and the one or more processors may be configured to: prior to the transition from the active mode of operation to the PSM of operation, receive, from the base station, an indication that MCG or the SCG supports the PSM of operation.

In example 16, which may also include one or more of the examples described herein, a baseband processor of a base station, comprising: one or more processors configured to: transmit, to a user equipment (UE) in an active mode of operation, one or more reference signals with an increased periodicity for radio link monitoring (RLM); and transition, to a user equipment (UE) in a power saving mode (PSM) of operation, one or more reference signals with a decreased periodicity for RLM.

In example 17, which may also include one or more of the examples described herein, the active mode of operation further includes performing beam failure detection (BFD) based on the one or more reference signals with the increased periodicity; and the PSM of operation further includes performing the BFD based on the one or more reference signals with the decreased periodicity. In example 18, which may also include one or more of the examples described herein, the active mode of operation further includes performing radio resource management (RRM) based on the one or more reference signals with the increased periodicity; and the PSM of operation further includes performing the BFD based on the one or more reference signals with the decreased periodicity.

In example 1, which may also include one or more of the examples described herein, the active mode of operation further comprises performing BFD and RRM based on one or more reference signals with an increased periodicity. In example 20, which may also include one or more of the examples described herein, the one or more reference signals with the increased periodicity includes system synchronizations blocks (SSBs), a channel state information (CSI) resource signal (CSI-RSs), or a combination of the SSBs and the CSI-RS; and the one or more reference signals with the decreased periodicity includes the SSBs, the CSI-RS, or the combination of the SSBs and the CSI-RS. In example 21, which may also include one or more of the examples described herein, the one or more processors may be configured to: prior to the transition from the active mode of operation to the PSM of operation, communicate an explicit indication for the UE in the active mode of operation to transition from the active mode of operation to the PSM of operation.

In example 22, which may also include one or more of the examples described herein, the explicit indication comprises a radio resource control (RRC) message with instructions to transition to the PSM of operation. In example 23, which may also include one or more of the examples described herein, the one or more processors may be configured to: communicate an indication that the base station supports the PSM of operation. In example 23, which may also include one or more of the examples described herein, the one or more reference signals with the increased periodicity corresponds to a same frequency range as the one or more reference signals with the decreased periodicity. In example 24, which may also include one or more of the examples described herein, the base station corresponds to a master cell group (MCG) or a SCG; and the one or more processors configured to: communicate an indication that MCG or the SCG supports the PSM of operation.

In example 25, which may also include one or more of the examples described herein, a method, computer-readable medium, and/or means may comprise: operating in an active mode of operation by performing radio link monitoring (RLM) based on one or more reference signals, from a base station, with an increased periodicity; and transitioning from the active mode of operation to a power saving mode (PSM) of operation by performing the RLM based on one or more reference signals, from the base station, with a decreased periodicity. In example 26, which may also include one or more of the examples described herein, a method, computer-readable medium, and/or means may comprise: transmitting, to a user equipment (UE) in an active mode of operation, one or more reference signals with an increased periodicity for radio link monitoring (RLM); and transitioning, to a user equipment (UE) in a power saving mode (PSM) of operation, one or more reference signals with a decreased periodicity for RLM.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, comprising:
a memory storing instructions;
one or more processors, when executing the instructions, configured to:
operate in an active mode by performing a radio link monitoring (RLM) based on one or more reference signals with a first rate; and
transition from the active mode to a power saving mode by performing the RLM based on one or more reference signals with a second rate smaller than the first rate.

2. The baseband processor of claim 1, wherein:
operating in the active mode further includes performing beam failure detection (BFD) based on the one or more reference signals with the first rate; and
operating in the power saving mode further includes performing the BFD based on the one or more reference signals with the second rate.

3. The baseband processor of claim 1, wherein:
operating in the active mode further includes performing radio resource management (RRM) based on the one or more reference signals with the first rate; and
operating in the power saving mode further includes performing the RRM based on the one or more reference signals with the second rate.

4. The baseband processor of claim 3, wherein the active mode further comprises performing BFD and RRM based on the one or more reference signals with the first rate.

5. The baseband processor of claim 1, wherein:
the one or more reference signals with the first rate includes system synchronizations blocks (SSBs), a channel state information (CSI) resource signal (CSI-RS), or a combination of the SSBs and the CSI-RS; and
the one or more reference signals with the second rate includes the SSBs, the CSI-RS, or the combination of the SSBs and the CSI-RS.

6. The baseband processor of claim 1, wherein the one or more processors are configured to:
prior to the transition from the active mode to the power saving mode,
receive an explicit indication to transition from the active mode to the power saving mode; and
transition to the power saving mode in response to the explicit indication to transition.

7. The baseband processor of claim 6, wherein the explicit indication comprises a radio resource control (RRC) message with instructions to transition to the power saving mode.

8. The baseband processor of claim 1, wherein the one or more processors are configured to:
prior to the transition from the active mode to the power saving mode,
detect an implicit indication to transition to the power saving mode; and
transition to the power saving mode in response to the implicit indication to transition.

9. The baseband processor of claim 8, wherein the implicit indication includes a secondary cell group (SCG) node being deactivated.

10. The baseband processor of claim 8, wherein the implicit indication includes a serving cell switching to a dormant bandwidth part (BWP).

11. The baseband processor of claim 8, wherein the implicit indication includes an equipment implementing the baseband processor being a low mobility equipment.

12. The baseband processor of claim 8, wherein the implicit indication includes an equipment implementing the baseband processor being located at a cell edge of a base station.

13. The baseband processor of claim 1, wherein the one or more processors are configured to:
prior to the transition from the active mode to the power saving mode,
receive an indication that the power saving mode is supported by a base station.

14. The baseband processor of claim 1, wherein the one or more reference signals with the first rate corresponds to a same frequency range as the one or more reference signals with the second rate.

15. The baseband processor of claim 1, wherein
the one or more processors are configured to:
prior to the transition from the active mode to the power saving mode,
receive an indication that the power saving mode is supported by a master cell group (MCG) or a secondary cell group (SCG).

16-27. (canceled)

28. A base station, comprising:
a memory storing instructions;
one or more processors, when executing the instructions, configured to cause the base station to:
transmit, to a user equipment (UE) in an active mode, one or more reference signals with a first rate for radio link monitoring (RLM); and
transition, to the UE in a power saving mode, one or more reference signals with a second rate smaller than the first rate for RLM.

29. The base station of claim 28, wherein:
the active mode further includes performing beam failure detection (BFD) based on the one or more reference signals with the first rate; and
the power saving mode further includes performing the BFD based on the one or more reference signals with the second rate.

30. A method, performed by a user equipment (UE), comprising:
receiving, from a base station, one or more reference signals with a first rate for operating in an active mode by performing radio link monitoring (RLM) based on the one or more reference signals with the first rate; and
receive, from the base station, one or more reference signals with a second rate smaller than the first rate for transitioning from the active mode to a power saving mode by performing the RLM based on the one or more reference signals with the second rate.

31. The method of claim 30, wherein:
the active mode further includes performing beam failure detection (BFD) based on the one or more reference signals with the first rate; and
the power saving mode further includes performing the BFD based on the one or more reference signals with the second rate.

32-33. (canceled)
